(19) United States
(12) Patent Application Publication
(10) Pub. No.: US 2006/0109969 A1
(43) Pub. Date: May 25, 2006

(54) System and method for providing an advertisement service using the call-connecting signal

(76) Inventor: Hyun-Seung Oh, Kyungi-do (KR)

Correspondence Address: John W. Renner;Renner Otto Boisselle & Sklar LLP, 1621 Euclide Avenue, 19th Floor, Cleveland, OH, 44115, US

(21) Appl. No.: 10/539,185

(22) PCT Filed: Dec. 15, 2003
(86) PCT No.: PCT/KR03/02746

§ 371 Date: Jun. 16, 2005

(30) Foreign Application Priority Data
Dec. 17, 2002 (KR) 10-2002-0080773

(51) Int. Cl. H04M 3/42

(52) U.S. Cl. 379/207.16

(57) ABSTRACT

Disclosed are system and method for providing an advertisement service using the call-connecting signal in the server of a common carrier. The method includes receiving a call request signal from the originator terminal, extracting an advertisement message from the advertisement database, and sending the advertisement message to the originator terminal. Also, the method further includes interrupting sending of the advertisement message if a call is connected between the originator terminal and the recipient terminal, extracting further commercial data related with the advertisement message, and sending the extracted further data to the originator terminal.

### TECHNICAL FIELD

The present invention relates to a system and method for providing an advertisement service using a ring back tone. More particularly, the present invention relates to a system and method for providing an advertisement service using a ring back tone in which an advertisement message is sent to an originator terminal as a ring back tone before a call connection is made between an originator and a recipient, and data related to the advertisement message is sent to the originator terminal when the call is ended.

### BACKGROUND ART

Each mobile common carrier presently provides a service in which music is played for the originator when he or she makes a call using his or her own portable terminal. The music is played until the recipient answers the call. This service is given different names depending on the provider, i.e., it is differently called “Coloring” in case of a speed 011 service of SK Telecom in Korea, “2Ring” in case of a 016 service of Korea Telecom Freetel (KTF) and “Feel Ring” in case of a 019 service of LG Telecom in Korea, respectively, and subscribers pay a set fee to receive the service. In addition, many methods are being developed in which there are provided advertisements targeted for during this period of playing music to the originator before the call is completed.

FIG. 1 is a flow chart of a conventional method for providing an advertisement service using a call connection signal. First, with reference to FIG. 1, if an originator presses a call key, an originator terminal connects to an advertisement transmitting tone generating device in step S10. Next, the advertisement transmitting tone generating device makes a call connection request to a recipient terminal in step S20. The advertisement transmitting tone generating device then extracts an advertisement transmitting tone and transmits the advertisement transmitting tone to the originator terminal in step S30. Subsequently, if a recipient responds to thereby realize phone reception, transmission and extraction of the advertisement transmitting tone are discontinued in step S40. The conventional advertisement service method using a ring back tone involved the processes as described above. However, with the use of such a conventional method, the advertisement message heard by the originator before the call is completed is typically abruptly ended when the call goes through. Even if the originator becomes interested in the product, service, etc. being advertised, no service is supported that allows for purchasing requests and purchasing steps to be taken. As a result, the return on advertising investment is minimized, as is the effectiveness of the advertisements.

Therefore, the originator listening to the advertisement has very little chance of finding the product being advertised. This, in turn, results in a very small number of willing advertising sponsors such that this method is almost never used. Further, such conventional advertising provides the advertisements of only one sponsor such that the sponsor must bear a significant expense for advertising. As mentioned above, the return on such an investment is minimal.

Accordingly, there is an ever-increasing need for a system and method for providing an advertisement service using a ring back tone that overcomes the drawbacks of the conventional advertisement service method that uses a ring back tone, and that provides more effective advertising using a ring back tone.

### DISCLOSURE OF INVENTION

The present invention has been made in an effort to solve the above problems. It is a first object of the present invention to provide a system and method for providing an advertisement service using a ring back tone in which following completion of a call, advertisement data such as characters corresponding to the sent advertisement message or pictures and drawings added to characters, or moving picture advertising messages are sent such that an originator may better appreciate the contents of an advertising message and remember the same for a longer period of time.

It is a second object of the present invention to provide a system and method for providing an advertisement service using a ring back tone that transmits purchasing information to the originator when a purchase information request is made by the originator such that the originator is able to view purchase information through his or her communications terminal.

It is a third object of the present invention to provide a system and method for providing an advertisement service using a ring back tone that processes a purchase order when the originator makes a purchase request to thereby allow the purchasing of products through an originator's communications terminal.

It is a fourth object of the present invention to provide a system and method for providing an advertisement service using a ring back tone that allows for the selection of a call-connect signal advertising sponsor or an advertising agency (hereinafter referred to as an “advertising sponsor”) according to time period such that a variety of advertisements may be offered.

It is a fifth object of the present invention to provide a system and method for providing an advertisement service using a ring back tone in which the advertising sponsor is selected through auction such that a greater advertising fee may be received from the sponsors at times when there are many calls.

It is a sixth object of the present invention to provide a system and method for providing an advertisement service using a ring back tone in which after a user becomes a member, advertisements of a desired sponsor may be individually designated and received at any time through the user's terminal or through the website of a common carrier or a company that has been consigned as an agent by contract with the common carrier to perform advertising duties (hereinafter referred to as “an advertising administration agency”), and in which benefits such as mileage rewards, etc. are received form the selected advertising sponsor. The advertising administration agency may perform a variety of duties such as sales with respect to an advertising sponsor and an advertising agency (normal sales and auctioning), organization and administration of advertising that is sold according to time period, advertising data transmission, processing of member purchase requests, and manufacturing advertising material for the advertising sponsor.

To achieve the above objects, one embodiment of the present invention provides a method for providing an advertisement service using a ring back tone in a common carrier server including receiving a call request signal from an originator terminal; extracting an advertisement message from an advertisement database; transmitting the advertisement message to the originator terminal; interrupting transmission of the advertisement message when a call connection is made between the originator terminal and a recipient terminal; extracting advertisement data corresponding to the advertisement message when a call is ended between the originator terminal and the recipient terminal; and transmitting the extracted advertisement data to the originator terminal.

In another embodiment, the present invention provides a method for providing an advertisement service using a ring back tone in an advertising administration agency server including receiving a call request signal of an originator terminal from a common carrier; extracting an advertisement message from an advertisement database; transmitting the advertisement message to the common carrier, the advertisement message being transmitted to the originator terminal through the common carrier; interrupting transmission of the advertisement message when a call connection signal is received from the common carrier; extracting advertisement data corresponding to the advertisement message when a call completion signal is received from the common carrier; and transmitting the extracted advertisement data to the common carrier, the advertisement data being transmitted to the originator terminal through the common carrier.

In yet another embodiment, the present invention provides a system for providing an advertisement service using a ring back tone including a memory in which a program is stored; and a processor for running the program in the memory. The processor performs the method for providing an advertisement service using a ring back tone as described above, and the processor performs the method using the program.

In still yet another embodiment, the present invention provides a system for providing an advertisement service using a ring back tone including a receiver receiving from a common carrier a call connection request signal of an originator terminal; a member management unit extracting information of an originator and a recipient from the call connection request signal to determine if the originator or the recipient is a member, and managing member information; an advertisement message extracting unit extracting advertisement messages to be transmitted from an advertisement message database; an advertisement data extracting unit extracting advertisement data from the advertisement database; and a transmitter transmitting an advertisement message extracted in the advertisement message extracting unit to the originator terminal through the common carrier after a member authorization signal is received from the member management unit, and transmitting advertisement data to the originator terminal through the common carrier when a call between the originator and the recipient is ended.

### BRIEF DESCRIPTION OF DRAWINGS

Further objects and advantages of the invention can be more fully understood from the following detailed description taken in conjunction with the accompanying drawings in which:

FIG. 1 is a flow chart of a conventional method for providing an advertisement service using a call connection signal.

FIG. 2 is a schematic view of a system for providing an advertisement service using a ring back tone according to a first embodiment of the present invention.

FIG. 3 is a schematic view of a system for providing an advertisement service using a ring back tone according to a second embodiment of the present invention.

FIG. 4 is a block diagram of an internal structure of an advertising administration agency server of FIG. 3.

FIG. 5 is a drawing conceptually showing a structure of a database of FIG. 4.

FIG. 6 is a drawing conceptually showing a structure of an advertising sponsor database of FIG. 5.

FIG. 7 is a drawing conceptually showing a structure of a transmission member database of FIG. 5.

FIG. 8 is a structural block diagram of a common carrier of FIG. 3.

FIG. 9 is a structural block diagram of a common carrier of FIG. 3 in the case where the common carrier provides MMS.

FIG. 10 is a flow chart showing processes of a terminal subscriber connecting to an advertising administration agency server and taking steps to become a member.

FIG. 11 is a flow chart showing a process of an advertising sponsor connecting to an advertising administration agency server and taking steps to become a member.

FIG. 12 is a flow chart showing a process of selecting an advertising sponsor, which desires to transmit advertisements using a ring back tone, through an auction and according to the time period.

FIG. 13 is a flow chart showing a process of a common carrier providing an advertisement service using a ring back tone according to a first embodiment of the present invention.

FIG. 14 is a flow chart showing a process of an advertising administration agency server providing an advertisement service using a ring back tone according to a second embodiment of the present invention.

FIG. 15 is a drawing showing an advertisement character message displayed on a screen of an originator terminal following call completion.

FIG. 16 is a drawing showing transmitted purchase information displayed on a screen of an originator terminal in the case where the originator makes a purchase information request.

### BEST MODE FOR CARRYING OUT THE INVENTION

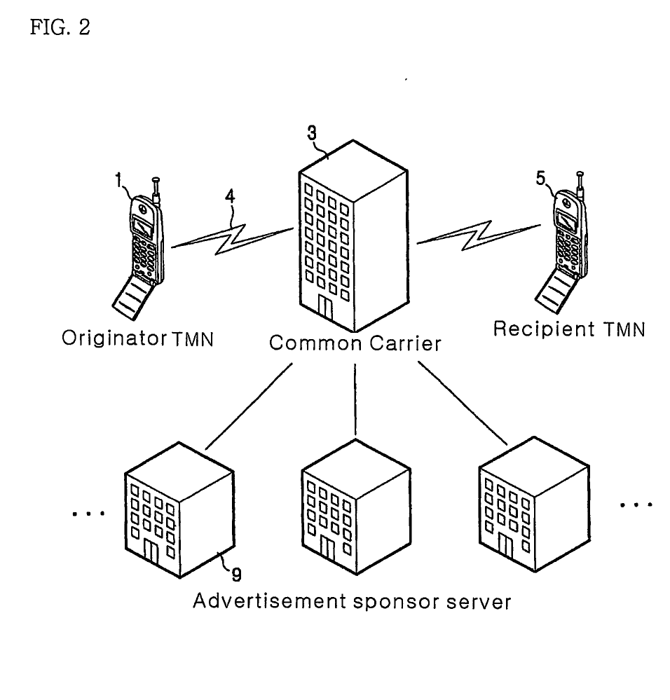

FIG. 2 is a schematic view of a system for providing an advertisement service using a ring back tone according to a first embodiment of the present invention. As shown in FIG. 2, a system for providing an advertisement service using a ring back tone according to a first embodiment of the present invention includes an originator terminal 1, a common carrier 3, a recipient terminal 5, and advertising sponsor servers 9.

The originator terminal 1 is a portable mobile communications terminal that connects with the common carrier 3 via a mobile communications network 4. Although the originator terminal 1 is typically a CDMA mobile phone, PCS mobile phone, etc., it is also possible to use a PDA or general wire telephone, a 2.5 G phone that enables EMS and MMS, or a 3 G phone. In the case where the originator or recipient is a subscriber to an advertisement service (that uses a ring back tone) provided from the common carrier 3, the originator terminal 1 receives advertisement messages from the common carrier 3 until call connection with the recipient terminal 5 is completed.

In addition to connecting call signals between the originator terminal 1 and the recipient terminal 5, the common carrier 3 provides advertisement messages instead of a call-connection signal during the time between when the originator makes a call to when connection with the recipient is made. The common carrier 3 may be a mobile common carrier or a traditional common carrier (that uses telephone lines). In the case where the common carrier 3 is a mobile common carrier; each mobile common carrier may be linked or affiliated with each other and the service of the present invention may be provided regardless of the service provider of the originator terminal 1 and recipient terminal 5.

Identical to the originator terminal 1, the recipient terminal 5 is a portable mobile communications terminal that connects with the common carrier 3 via a mobile communications network 4. The recipient terminal 5 is generally a CDMA mobile phone, a PCS mobile phone, a PDA or a general wire telephone, and can be a 2.5 G phone that enables EMS and MMS, or a 3 G phone. The advertising sponsor servers 9 are computers provided in the head office of companies that subscribe to an advertisement service using a ring back tone of the common carrier 3. The advertising sponsor servers 9 are networked with the common carrier 3 by a TCP/IP or PPP method, and transmit advertisement messages, advertisement data, and various information such as purchase information to the common carrier 3.

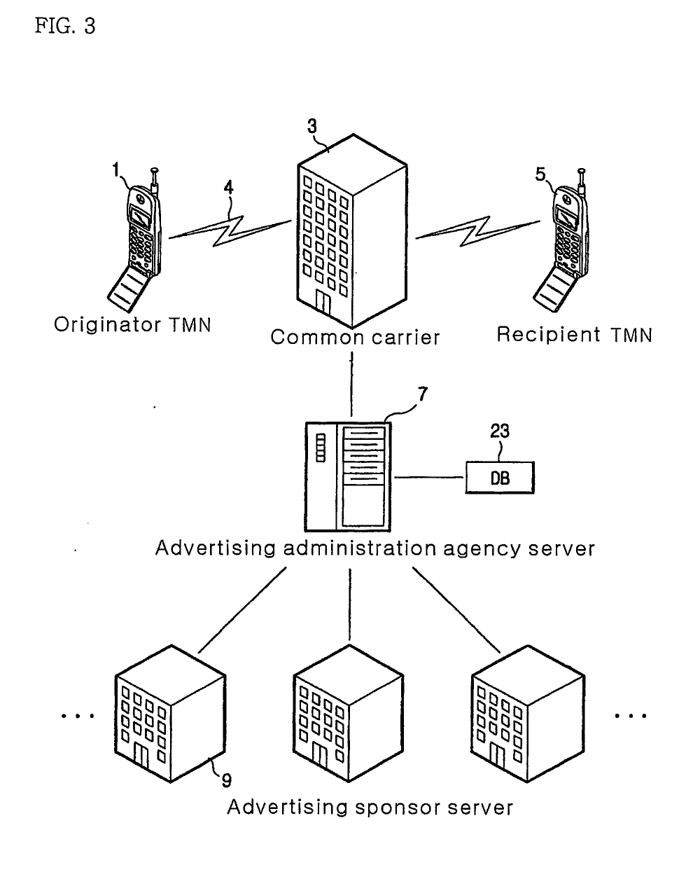

FIG. 3 is a schematic view of a system for providing an advertisement service using a ring back tone according to a second embodiment of the present invention. As shown in FIG. 3, a system for providing an advertisement service using a ring back tone according to a second embodiment of the present invention includes an originator terminal 1, a common carrier 3, a recipient terminal 5, advertising sponsor servers 9, and also advertising administration agency servers 7. Since the structures of the originator terminal 1, the recipient terminal 5, and the advertising sponsor servers 9 are identical to structures described with reference to FIG. 2, a description thereof will not be repeated.

In addition to connecting call signals between the originator terminal 1 and the recipient terminal 5, the common carrier 3 receives advertisement messages, advertisement data, and purchase information from the advertising administration agency server 7 during the time between when the originator makes a call to when connection with the recipient is made. As described above, the common carrier 3 may be a mobile common carrier or a traditional common carrier (that uses telephone lines). In the case where the common carrier 3 is a mobile common carrier, each mobile common carrier may be linked or affiliated with each other and the service of the present invention may be provided regardless of the service provider of the originator terminal 1 and recipient terminal 5.

The advertising administration agency server 7 is a computer provided in a head office of an advertising management agency that performs the method of the present invention of providing an advertisement service using a ring back tone, or in a head office of a common carrier, or in a wireless or wired data center. The advertising administration agency server 7 is connected to the common carrier 3 and the advertising sponsor servers 9 via a network. Further, the advertising administration agency server 7 includes a database 23 that stores member information, advertisement messages, advertisement data, purchase information, etc. A detailed description of the database 23 will be provided below.

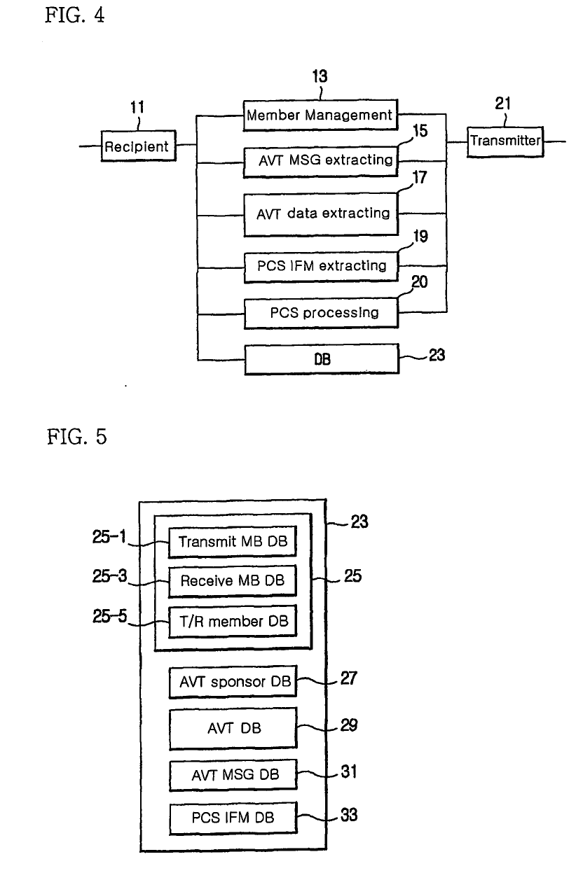

FIG. 4 is a block diagram of an internal structure of the advertising administration agency server 7 of FIG. 3. As shown in FIG. 4, the advertising administration agency server 7 includes a receiver 11, a member management unit 13, an advertisement message extracting unit 15, an advertisement data extracting unit 17, a purchase information extracting unit 19, a purchase processor 20, a transmitter 21, and a database 23.

The receiver 11 receives from the common carrier 3 a call connection request signal and a call completion signal of the originator terminal 1. That is, if a call key, completion key, or any other key designated by other companies to realize a service is pressed on the originator terminal 1, a call connection request signal or call completion signal is transmitted to the common carrier 3. The common carrier 3 then transmits the received call connection request signal or call completion signal to the advertising administration agency server 7.

The member management unit 13 manages member information by registering members and storing information of the members that have subscribed to the advertisement service using a ring back tone of the present invention. Further, when a call connection request signal is received, the member management unit 13 extracts from this signal originator and recipient information to determine if the originator and recipient are members

The advertisement message extracting unit 15 extracts advertisement messages to be transmitted to the originator terminal 1. In this embodiment of the present invention, advertisement message extraction according to the period of time, advertisement message extraction depending on customer, advertisement message extraction depending on area, etc. are performed. The advertisement data extracting unit 17 extracts advertisement data. If the receiver 11 receives a call completion signal, the advertisement data extracting unit 17 extracts advertisement data to be transmitted to the originator terminal 1. Advertisement data may include character messages, drawings, pictures, moving pictures, and files, or various multimedia data that mix these different data formats.

The purchase information extracting unit 19 extracts purchase information to be transmitted to the originator terminal 1. If a purchase information request signal is received from the originator terminal 1, the purchase information extracting unit 19 extracts purchase information related to the advertisement message. The purchase information includes product catalog data, estimate data, etc.

In the case where a purchase request signal that includes purchase product information is received from the originator terminal 1, the purchase processor 20 performs purchase processing of the purchase product using this information. The purchase processor 20 extracts originator information and product information, and transmits the same to the advertising sponsor server 9 of the advertising sponsor in charge of the particular product. Further, the purchase processor 20 directly performs purchase processing such as establishing contracts with the advertising sponsor, settling accounts, etc.

After a member authorization signal is received from the member management unit 13, the transmitter 21 transmits the advertisement message extracted in the advertisement message extracting unit 15, to the originator terminal and also transmits advertisement data to the originator terminal 1 when the call between the originator and the recipient is ended.

The database 23 will be described in greater detail with reference to FIGS. 5, 6, and 7. FIG. 5 is a drawing conceptually showing a structure of the database 23 of FIG. 4. As shown in FIG. 5, the database 23 includes a member database 25, an advertising sponsor database 27, an advertisement database 29, an advertisement message database 31, and a purchase information database 33.

The member database 25 stores the information of terminal users subscribing to the advertisement service using a ring back tone provided by the common carrier 3 or the advertising administration agency server 7. The member database 25 may also store advertisement type selected by users. In addition, the member database 25 may store advertisements of advertising sponsors or information of advertisements selected whenever desired through the user terminal or the website of an advertising administration agency. The member database 25 includes (for use depending on the type of service subscribed by the member) a transmitting member database 25-1, a receiving member database 25-3, and a transmitting/receiving member database 25-5. The transmitting member database 25-1 registers and stores information of a member that selects a transmitting member system that, when the subscriber performs transmission, enables advertising messages of a common carrier or advertising messages organized by an advertising administration agency, or advertising messages of a specific advertising sponsor selected by the subscriber or of an advertising sponsor to be received to the subsciber, and either collects an advertisement receiving fee from the service subscribing member or provides mileage points or other benefits such as product discounts. The receiving member database 25-3 registers and stores information of a service subscribing member that selects a receiving member system that enables the originator to receive advertisement messages when the originator performs transmission to the terminal of the service subscribing member, and either collects an advertisement reception fee from the service subscribing member, or provides mileage points or other benefits such as product discounts. The transmitting/receiving member database 25-5 selects both a transmitting member system and a receiving member system, and registers and stores information of a member that selects a transmitting/receiving member system that enables a recipient (when the member is an originator) and an originator (when the member is a recipient) to listen to advertisement messages.

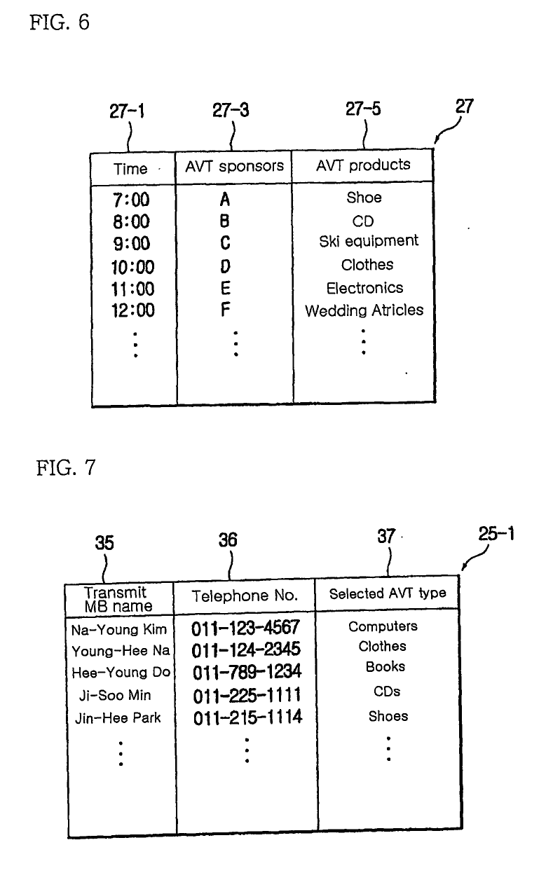

The advertising sponsor database 27 stores information of the advertising sponsor that provides an advertisement service using a ring back tone through the advertising administration agency server 7. The advertising sponsor database 27 will be described in greater detail below with reference to FIG. 6. The advertisement database 29 stores advertisement data that is transmitted to the originator terminal 1 when the receiver 11 receives a call completion signal from the common carrier 3. As described above, advertisement data may include character messages, drawings, pictures, moving pictures, and files, or various multimedia data that mix these different data formats.

The advertisement message database 31 stores advertisement messages provided during the time interval between when the originator makes a call and when the recipient receives the call. The purchase information database 33 stores purchase information that is transmitted to the originator terminal 1 when a purchase information request signal is received from the originator terminal 1.

FIG. 6 is a drawing conceptually showing a structure of the advertising sponsor database 27 of FIG. 5. As shown in FIG. 6, information of time periods 27-1, advertising sponsors 27-3, and advertising products 27-5 is stored in the advertising sponsor database 27. The advertising sponsor database 27 may also store classification information of advertising sponsors according to area. Times when advertisements of each advertising sponsor are provided are stored in the time periods 27-1. That is, according to FIG. 6, advertising times are such that the advertising sponsors may be changed every hour. However, the present invention is not limited to this arrangement and it is possible to change the advertising sponsors every 30 minutes, every 2 hours, every 3 hours, etc. Further, since the products handled for each advertising sponsor and their time periods may differ, a time period allotment using an auction process is realized. This will be described below. Therefore, even if an advertisement is provided during the same time period, the associated fees may be different according to the call amount of the member or the advertising sponsor.

Advertising sponsors selected through auction to provide the service of the present invention for each time period are stored in the advertising sponsor 27-3. In FIG. 6, although a hypothetical situation is shown in which each of the time periods is allotted to a different advertising sponsor, it should be clear that a single advertising sponsor may occupy a plurality of time slots.

The advertising products 27-5 is where there are stored products handled by advertising sponsors, which are allotted time periods, and that the advertising sponsors desire to advertise. For example, shoes may be stored as the advertising product for company A, and CDs may be stored as the advertising product for company B. In FIG. 6, a single advertising product is stored for each advertising sponsor. However, the present invention is not limited in this regard and it is possible to store a plurality of advertising products for each advertising sponsor, and to transmit terminal subscriber information or advertising messages with respect to advertising products extracted according to advertising type desired by a subscriber. Further, it is also possible to have advertising sponsors placed on stand-by and to transmit advertising messages that match member characteristics (age, area, income distribution, sex, religion, etc.).

FIG. 7 is a drawing conceptually showing a structure of the transmission member database 25-1 of FIG. 5. Since the structures of the receiving member database 25-3 and the transmitting/receiving member database 25-5 are identical to the structure of the transmission member database 25-1, an explanation of only the transmission member database 25-1 will be given. As shown in FIG. 7, the transmission member database 25-1 stores transmission member names 35, telephone numbers 36, selected advertisement type 37, etc. The transmission member names 35 is where there are stored name data of members that select transmission member systems. In FIG. 7, the names are listed in alphabetical order. The telephone numbers 36 is where there are stored telephone numbers of transmission members. In FIG. 7, all transmission members are assumed to use the same service provided. However, the present invention is not limited in this regard and it is possible for the subscribers to belong to different communications companies in the case where the communications companies are linked or affiliated as described above.

The selected advertisement type 37 is where there is stored information of advertisement type selected when transmission members subscribe and that they desire to listen. This element is needed when there are provided to an originator terminal advertisement types desired by the originator. Therefore, this element is unneeded when different advertisement types desired by the originator are not offered, and when the advertisement messages are uniformly provided according to time period.

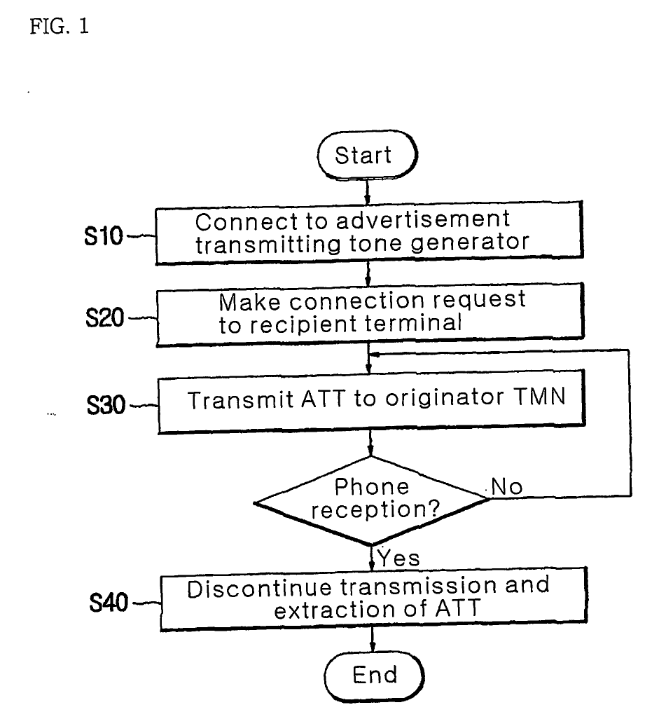

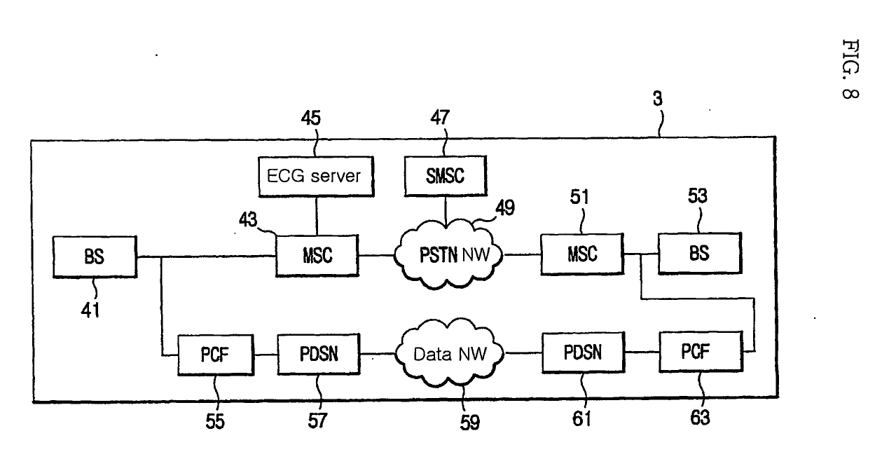

FIG. 8 is a structural block diagram of the common carrier 3 of FIG. 1. As shown in FIG. 8, the common carrier 3 includes BSs 41 and 53, MSCs 43 and 51, an exchanger server 45, an SMSC 47, PCFs 55 and 63, and PDSNs 57 and 61. The BSs 41 and 53 are base stations that transmit and receive data through the wireless communications network 4 and to and from the originator terminal 1 or the recipient terminal 5, and each includes a BTS (not shown) and a BSC (not shown). The BTS (Base Station Transceiver System) is a device that performs wireless communications with the terminals 1 and 5 (MSs or mobile stations) in a cell. Call request signals, call completion signals, advertisement messages, advertisement data, and data of purchase information are transmitted and received between the terminals 1 and 5 and the advertising administration agency server 7 through the BTS. To realize this, the BTS performs encoding and decoding of wireless channels, and transmits and receives wireless signals to and from the terminals 1 and 5. In addition, in order to provide better call reception and more economically provide an SMS service, the BTS performs the functions of transmission/reception signal strength adjustment, upstream link quality measurement, a space diversity function, wireless source management, and a self-maintenance function. The BSC (Base Station Controller) performs the matching with a plurality of BTSs to perform the functions of hands-off processing between cells, call control, base station application and maintenance control.

The MSCs (Mobile Station Controllers) 43 and 51 provide a link between a mobile communications network and a fixed network such as a PSTN or an ISDN, and provide a link between a mobile communications network and networks of other companies such as PLMN, the Internet network, and PSPDN. In the embodiment of the present invention, the MSCs 43 and 51 perform a matching process to realize the matching with the BSs 41 and 53, and perform transmission and reception of data that are transmitted to and received from the BSs 41 and 53 such as call request signals, call completion signals, advertisement messages, advertisement data, and purchase information. That is, these data are transmitted to the BSs 41 and 53 from the advertising administration server 7 and received from the BSs 41 and 53 for transmission to the advertising administration server 7. The MSCs 43 and 51 exchange information with an HLR (Home Location Register, not shown) and a VLR (Visitor Location Register, not shown) that store subscriber information in order to perform an exchange function, and are matched with the BSs 41 and 53 to transmit and receive signal and voice data with a subscriber terminal 10.

According to the first embodiment of the present invention, the exchanger server 45 acts as a server to provide advertisement service in the case where the common carrier 3 directly provides an advertisement service using a ring back tone. The exchanger server 45 has almost the same structure and function as the advertising administration agency server 7 of FIG. 4.

The SMSC (Short Message Service Center) 47 is a device to provide a character message service. In the case where the common carrier 3 directly provides service following the completion of a call between the originator and the recipient, the SMSC 47 sends a character message transmitted from the exchanger server 45 to the originator terminal 1 through the MSCs 43 and 51 and the BSs 41 and 53. In the case where service is provided by the advertising administration agency server 7, the SMSC 47 sends a character message transmitted from the advertising administration agency server 7 to the originator terminal 1 through the MSCs 43 and 51 and the BSs 41 and 53.

The PCFs 55 and 63 control transmitted data packets. In particular, following completion of a call between the originator and the recipient and in the case where the common carrier directly provides service, the PCFs 55 and 63 transmit multimedia data such as moving pictures, files, etc. related to advertisements transmitted from the exchanger server 45 to the originator terminal 1 through the MSCs 43 and 51 and the BSs 41 and 53. Further, in the case where service is provided by the advertising administration agency server 7, the PCFs 55 and 63 transmit multimedia data of moving pictures, files, etc. related to advertisements transmitted from the advertising administration agency server 7 to the originator terminal 1 through the MSCs 43 and 51 and BSs 41 and 53. The PDSNs (Packet Data Switching Nodes) 57 and 61 provide an interface for the transmission of data packets between the BSs 41 and 53 and a data network 59.

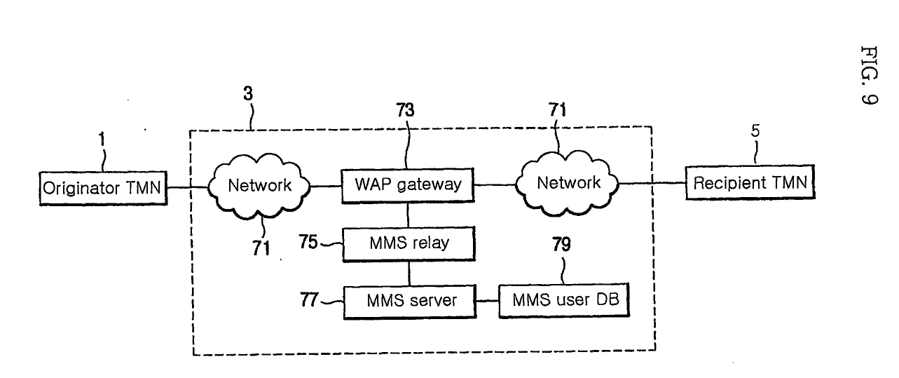

FIG. 9 is a structural block diagram of the common carrier 3 of FIG. 3 in the case where the common carrier 3 provides MMS. As shown in FIG. 9, the common carrier 3 providing MMS (Multimedia Messaging Service) includes WAP gateway 73, an MMS relay 75, and an MMS server 77.

The WAP gateway 73 is a type of gateway for connecting networks having differing structures. The WAP gateway 73 is connected to the originator terminal 1 and the recipient terminal 5 through a communications network 71, and connected to the MMS server 77 through the MMS relay 75. Further, the WAP gateway 73 employs WAP (Wireless Application Protocol), which is a mobile computer architecture that enables wireless devices such as a CDMA portable terminal to be connected to the Internet.

The MMS relay 75 performs coding and decoding of MMS messages, and a format matching function. The MMS server 77 performs transcoding of address formats and message formats (for example, converting WML format into HTML), and transmitting and receiving of MMS messages. Further, the MMS server 77 includes an MMS database for storing subscriber information of MMS subscribers and transmission/reception information. This structure of the common carrier 3 is such that it can provide EMS (Enhanced Messaging Service), MMS, etc., in addition to the conventional SMS.

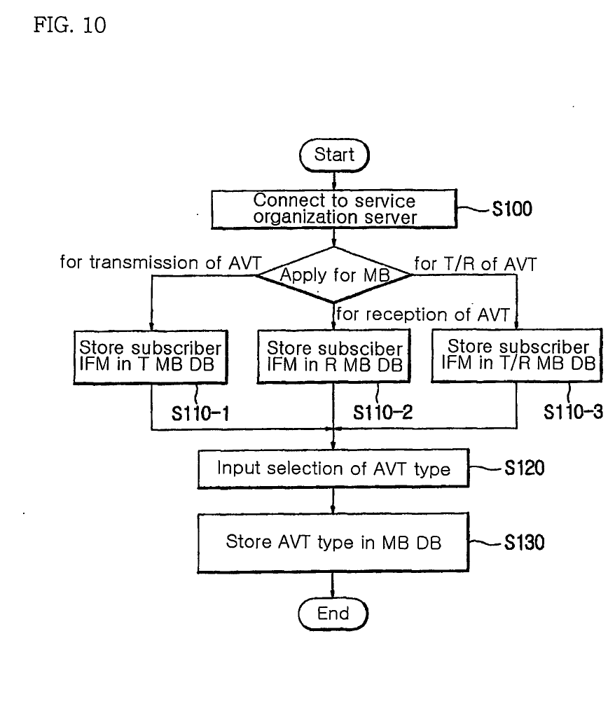

FIG. 10 is a flow chart showing processes of a terminal subscriber connecting to the advertising administration agency server 7 and taking steps to become a member. With reference to FIG. 10, first, a terminal subscriber connects to the advertising administration agency server 7 in step S100. The terminal subscriber connects to the advertising administration agency server 7 via the Internet or using a wireless Internet. Subsequently, the terminal subscriber applies to become a member in step S110. During this step, the applicant becomes a specific type of member depending on the type of service he or she selects. That is, depending on the type of service selected during application, the applicant becomes a transmitting member, a receiving member, or a transmitting/receiving member.

To describe member types in more detail, a transmitting membership is such that when a subscriber makes a call to another person, the subscriber is able to listen to advertisement messages. Accordingly, an advertising reception fee is paid to the member or some other benefit is provided such as giving mileage points or product discounts. If a subscriber joins as a transmitting member, the subscriber information is stored in the transmitting member database 25-1 in step S110-1.

A receiving membership is such that when someone calls a member subscriber, this person is able to hear advertising messages such that an advertising reception fee is paid to the member or some other benefit is provided such as giving mileage points or product discounts. If a subscriber joins as a receiving member, subscriber information is stored in the receiving member database 25-3 in step S110-2. A transmitting/receiving membership is such that both the transmitting member and receiving member services are offered. If a subscriber joins as a transmitting/receiving member, subscriber information is stored in the transmitting/receiving member database 25-5 in step S110-3. After a subscriber registers as a member, he or she selects the desired advertisement type, then this information is transmitted to the advertising administration agency server 7 in step S120. That is, this step involves selection of the type of advertising the subscriber desires to hear when making a phone call.

The advertising administration agency server 7 then stores the received advertisement type in the member database 25 in step S130. The transmission and storage of advertisement type is needed in the case where the advertising administration agency server 7 provides a service of transmitting advertising messages corresponding to the advertisement types selected by subscribers. This step need not be taken if the advertising administration agency server 7 uniformly provides advertisement messages.

Members may apply for or revise advertisements of specific advertising sponsors that they desire to receive at any time using their terminals, or through the website of a common carrier or an advertising administration agency. Further, subscribers may join to become members at an on-line site of a common carrier or at a physical agency thereof. At this time, if a separate contract is made that consigns advertising service business to an advertising administration agency, the information required from among the member data may be shared.

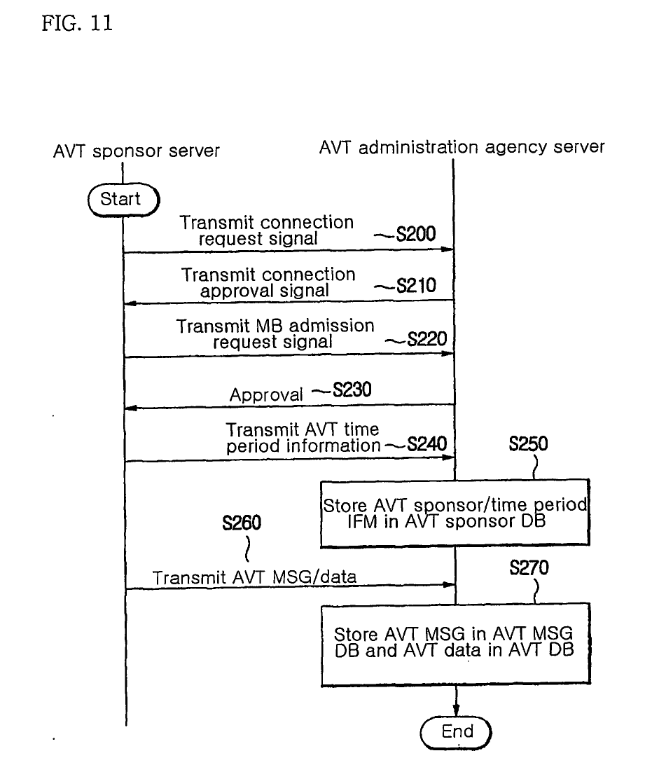

FIG. 11 is a flow chart showing a process of an advertising sponsor connecting to the advertising administration agency server 7 and taking steps to become a member. The advertising sponsor server 9 transmits a connection request signal to the advertising administration agency server 7 in step S200, then receives a connection approval signal and connects with the advertising administration agency server 7 in step S210. If connection is realized, the advertising sponsor server 9 transmits a member admission request signal to the advertising administration agency server 7 in step S220, then receives a member admission approval signal to thereby register as a member in step S230. If registration as a member is realized, the advertising sponsor server 9 transmits information of desired advertising time periods to the advertising administration agency server 7 in step S240, after which the advertising administration agency server 7 stores the received advertising sponsor information and the advertising time period information in the advertising sponsor database 27 in step S250. Finally, if the advertising sponsor server 9 transmits advertisement messages and advertisement data such as character messages to the advertising administration agency server 7 in step S260, the advertising administration agency server 7 stores the advertisement messages in the advertisement message database 31 and the advertisement data in the advertisement database 29 in step S270.

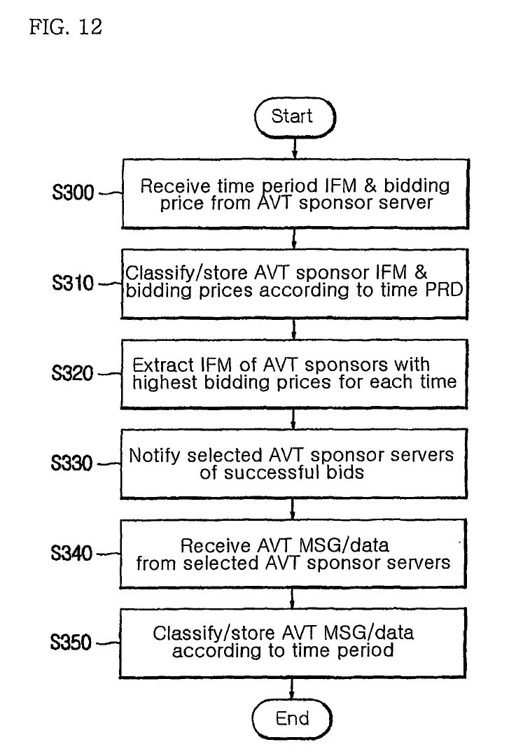

FIG. 12 is a flow chart showing a process of selecting an advertising sponsor, which desires to transmit advertisements using a ring back tone, through an auction and according to the time period. The advertising administration agency server 7 receives from the advertising sponsor server 9 desired time period information and bidding price in step S300. A minimum bidding price for each time period is stored in the advertising administration agency server 7, and this information is immediately transmitted to the advertising sponsor at the time of becoming a member such that the advertising sponsor may perform bidding in a more informed manner. A plurality of time periods and corresponding bidding prices also may be received from the advertising sponsor server 9. That is, the advertising sponsor may select multiple time periods and submit a bid for each of the time periods.

The advertising administration agency server 7 classifies the advertising sponsor information and bidding prices according to time period and stores the same in step S310. The advertising administration agency server 7 extracts information of the advertising sponsors having the highest bidding prices for each of the time periods, and selects these advertising sponsors as successful bidders in step S320. Next, the advertising administration agency server 7 transmits the successful bidder information to the selected advertising sponsor servers 9 to thereby provide notification of successful bids in step S330. The advertising administration agency server 7 then receives from the selected advertising sponsor servers 9 desired advertisement messages and advertisement data in step S340. Subsequently, the advertising administration agency server 7 classifies and stores the advertising messages and advertisement data according to time period in step S350.

Assignment of advertising messages according to time period and to advertising sponsors using an auctioning process as described with reference to FIG. 12 is a description of one embodiment. It is to be understood that auctioning of the time periods need not be performed as shown in FIG. 11. That is, advertising sponsors may be allotted desired time periods using pre-designated advertising fees. Also, advertising type desired by subscribers may be provided without taking into consideration different time periods.

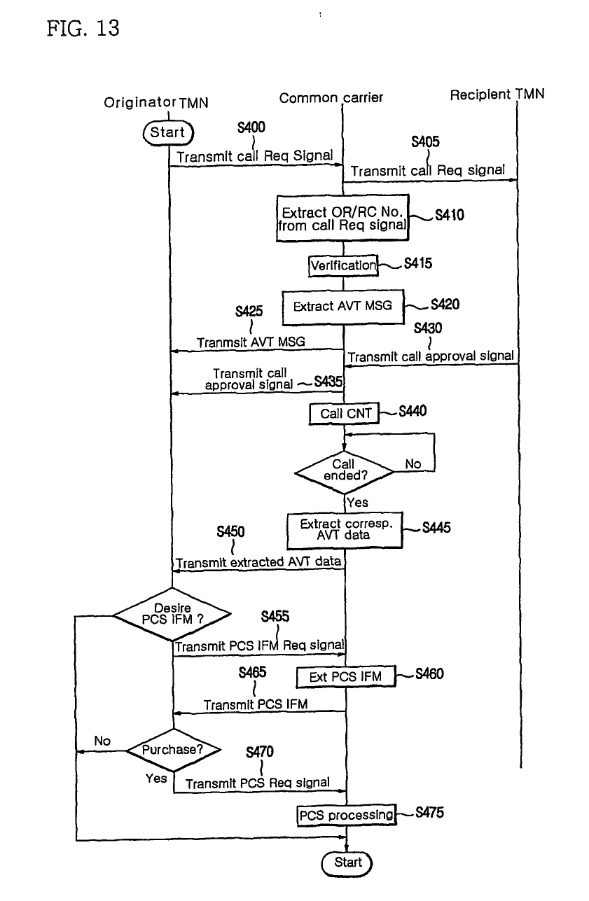

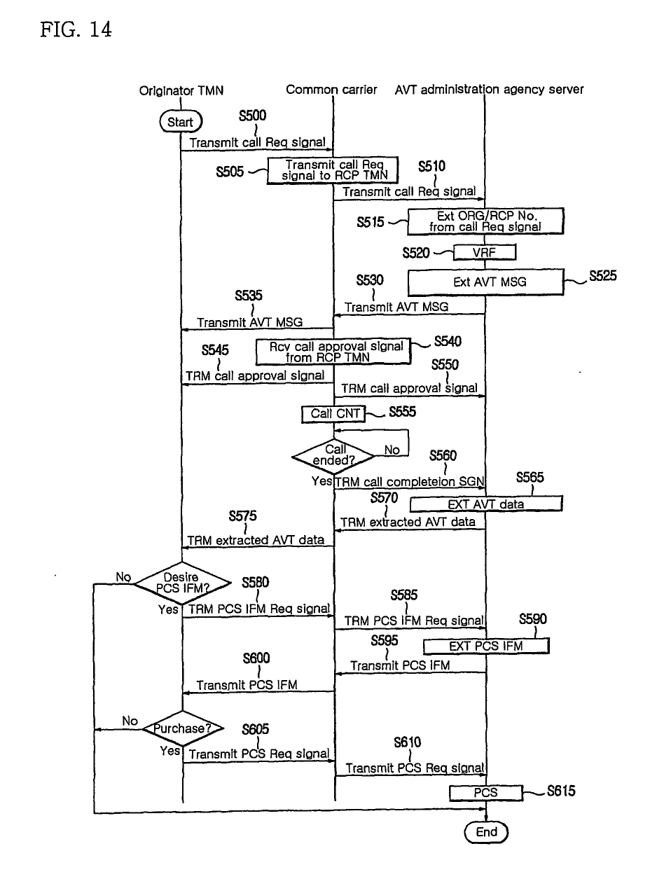

In the following, a method of providing an advertisement service using a ring back tone will be described with reference to FIGS. 13 and 14, after which the method will be described in greater detail by citing various embodiments. FIG. 13 is a flow chart showing a process of the common carrier 3 providing an advertisement service using a ring back tone according to a first embodiment of the present invention. Although not described herein, it should be understood that, in addition to characters, various types of multimedia message information may also be provided.

The common carrier 3 receives a call request signal from the originator terminal 1 in step S400, transmits the call request signal to the recipient terminal 5 in step S405, extracts an originator number and a recipient number included in the call request signal in step S410, then performs member verification in step S415. If member confirmation is made, the common carrier 3 extracts advertisement messages in step S420, and transmits the advertisement messages to the originator terminal 1 in step S425. Next, if a call approval signal is received from the recipient terminal 5 in step S430, the common carrier 3 transmits the call approval signal to the originator terminal 1 in step S435, then makes a call connection and interrupts message transmission in step S440.

If the call is ended, the common carrier 3 extracts the corresponding advertisement character message in step S445, then transmits the message to the originator terminal 1 in step S450. The received advertisement character message is stored in the originator terminal 1 according to time period. Next, a purchase information request signal is received from the originator terminal 1, which received the advertisement character message, in step S455. The common carrier 3 then extracts from this signal purchase information in step S460, and transmits the purchase information to the originator terminal 1 in step S465. If a purchase request signal is received from the originator terminal 1, which received the purchase information, in step S470, the common carrier 3 performs purchase processing in step S475.

FIG. 14 is a flow chart showing a process of the advertising administration agency server 7 providing an advertisement service using a ring back tone according to a second embodiment of the present invention. The common carrier 3 receives a call request signal from the originator terminal 1 in step S500, then transmits the call request signal to the recipient terminal 5 and advertising administration agency server 7 in steps S505 and S510.

The advertising administration agency server 7 extracts an originator number and a recipient number contained in the call request signal in step S515, then performs member verification in step S520. If member confirmation is made, the advertising administration agency server 7 extracts advertisement messages in step S525, and transmits the advertisement messages to the originator terminal 1 through the common carrier 3 in steps S530 and S535. Next, if a call approval signal is received from the recipient terminal 5 in step S540, the common carrier 3 transmits the call approval signal to the originator terminal 1 and the advertising administration agency server 7 in steps S545 and S550, then makes a call connection and interrupts message transmission in step S555. If a call completion signal is received from the common carrier 3 in step S560, the advertising administration agency server 7 extracts the corresponding advertisement character message in step S565, then transmits the message to the originator terminal 1 through the common carrier 3 in steps S570 and 575. The transmitted advertisement character message is stored in the originator terminal 1 according to time period.

Next, if a purchase information request signal is received from the original terminal 1, which received the advertisement character message, through the common carrier 3 in steps S580 and S585, the advertising administration agency server 7 extracts from this signal purchase information in step S590, and transmits the purchase information to the originator terminal 1 through the common carrier 3 in steps S595 and S600. If a purchase request signal is received from the originator terminal 1, which received the purchase information, through the common carrier 3 in steps S605 and S610, the advertising administration agency server 7 performs purchase processing in step S615.

Each embodiment providing service from the advertising administration agency server 7 will be described below. To simplify matters, steps performed by the common carrier 3 will be omitted. The method of providing an advertisement service using a ring back tone of the present invention may be fully understood through the following embodiments.

(Transmitting Members)

In the case where a terminal subscriber connects to the advertising administration agency server 7 and registers as a transmitting member, the advertising administration agency server 7 registers the terminal subscriber as a transmitting member. If an originator that registers as a member presses the call key, a call request signal is transmitted to a common carrier. The common carrier then determines whether or not the originator is an advertising administration agency server member, and transmits the call request signal to the advertising administration agency server 7 if the originator is a member.

The advertising administration agency server 7 extracts an originator, number included in the call request signal and compares this with information in the member database 25 to determine if the originator is a transmitting member. If it is determined that the originator is a transmitting member, the advertising administration agency server 7 extracts present time information, extracts an advertising message of an advertising sponsor corresponding to the present time period, then transmits the advertising message to the originator terminal 1. The advertising message is provided until the call connection is made. As a result of receiving the advertising message, the originator receives an advertising fee or another benefit such as mileage points or product discounts.

If the call between the originator and recipient is ended, the advertising administration agency server 7 extracts the advertising character message related to the advertisement provided prior to call connection and transmits the same to the originator terminal 1. If the originator desires purchase information after immediately checking the advertising character message (or after checking this message and other stored advertising messages at a later time), the requested information is provided from the advertising administration agency server 7 after the call key 101 or save key 103 appearing on a screen 100 of the originator terminal 1 is pressed. The originator may then make a purchase request after viewing the purchase information.

If a purchase request signal is transmitted from the originator terminal 1, the advertising administration agency server 7 either directly settles the purchase order or transmits originator information and the purchase request signal to the advertising sponsor server 9 to thereby realize purchasing. If a purchase order is made, the originator accumulates mileage points and the advertising administration agency server 7 transmits the accumulated mileage points to the originator terminal 1.

(Receiving Members)

In the case where a terminal subscriber connects to the advertising administration agency server 7 and registers as a receiving member, the advertising administration agency server 7 registers the terminal subscriber as a receiving member. If the originator inputs the subscriber terminal (recipient terminal) number registered as a member, then presses the call key, a call request signal undergoes the processes of passing through the common carrier, etc. and is transmitted to the advertising administration agency server 7. The advertising administration agency server 7 extracts a recipient number included in the call request signal and compares this with information in the member database 25 to determine if the recipient is a receiving member. If it is determined that the recipient is a receiving member, the advertising administration agency server 7 extracts present time information, extracts an advertising message of an advertising sponsor corresponding to the present time period, then transmits the advertising message to the recipient terminal 1. The advertising message is provided until the call connection is made. As a result, the recipient receives an advertising fee or another benefit such as mileage points or product discounts. The subsequent processes are identical to those associated with transmitting members and so a description thereof will not be repeated.

(Transmitting/Receiving Member)

In the case where a terminal subscriber connects to the advertising administration agency server 7 and registers as a transmitting/receiving member, the advertising administration agency server 7 registers the terminal subscriber as a transmitting/receiving member. If an originator that is a transmitting/receiving member makes a call, or an originator inputs a terminal number of a recipient that is a transmitting/receiving member then presses the call key, a call request signal is transmitted to the advertising administration agency server 7. The advertising administration agency server 7 then extracts an originator number and a recipient number included in the call request signal, and compares this with information in the member database 25 to determine if the originator or the recipient is a transmitting/receiving member.

If it is determined that the originator or the recipient is a transmitting/receiving member, the advertising administration agency server 7 extracts present time information, extracts an advertising message of an advertising sponsor corresponding to the present time period, then transmits the advertising message to the originator terminal 1. The advertising message is provided until the call connection is made. As a result, the originator or the recipient (whichever is the transmitting/receiving member) receives an advertising fee or another benefit such as mileage points or product discounts. The subsequent processes are identical to those associated with transmitting members and so a description thereof will not be repeated. If both the originator and the recipient are transmitting/receiving members, the originator receives the advertising message, and the originator and the recipient both receive an advertising fee or another benefit such as mileage points or product discounts.

In the case where a service is provided in which advertising messages of an advertisement type selected by the member are transmitted, and the originator and the recipient are both transmitting/receiving members, it is possible to process such a situation by agreed upon rules. For example, it may be a rule that the originator is given priority in this case, or that another pre-designated advertisement message is transmitted. Such an arrangement may also be applied in the case where the originator is a transmitting member and the recipient is a receiving member.

(CDs, etc.)

This embodiment is related to the case where advertising provided as advertisement messages is music used to promote the sale of CDs. If the originator presses the call key, the advertising administration agency server 7 transmits predetermined advertising music to the originator terminal 1 until call connection is made. These advertisements can be provided such that information related to the music such as the singer, composer, performer, etc. is displayed on the liquid crystal display or dubbed as background narration while the music is being played.

After completion of the call, additional information related to the advertisement provided is transmitted through an advertisement character message. If the originator desires to purchase the CD containing the song just heard, the call key 101 or the save key 103 on the screen 100 of the originator terminal 1 is selected. The advertising administration agency server 7 then transmits information of the CD containing the song to the originator terminal 1. The CD information may include a view of the CD cover, the producer, a list of the songs, sale price, etc. It is also possible for the originator to view, at any time, information stored in an advertisement reception folder then go through these purchasing processes if a decision to purchase is made.

If the originator views CD information and makes a purchase request, the advertising administration agency server 7 either directly handles the purchase order or transmits originator information and the CD information to the corresponding advertising sponsor server 9 to thereby realize purchasing.

(Transmission of Advertisements According to Customer)

If a terminal subscriber connects to the advertising administration agency server 7, registers as a member, and transmits a desired advertisement type, the advertising administration agency server 7 stores subscriber information and advertisement type in the member database 25. For example, if Jeff Bright in FIG. 7 selects “clothes” as the desired advertisement type, “Jeff Bright” and “clothes” are stored in the transmitting member database 25-1.

If Jeff Bright makes a call to a friend, the advertising administration agency server 7 goes through the member verification process, then extracts an advertisement message of Company D, which is an advertising sponsor that includes advertisement products corresponding to the advertisement type selected by Jeff Bright (i.e., clothes), and transmits the advertisement message to the originator terminal 1. The subsequent processes of providing mileage points or product discounts, etc. are identical to those described above and therefore a description thereof will not be repeated.

(Transmission of Advertising According to Area)

The advertising administration agency server 7 groups advertising sponsors according to area when advertising sponsors join to become members. The advertising sponsors may be grouped together according to district, city, town, etc. Further, after the advertising sponsors are grouped according to area, the advertising sponsors in each group may be allotted different time slots. In addition, only part of the 24-hour advertising operation time may be designated as an area advertising time period, during which time area advertisements are grouped together and the advertisements provided in this manner. If no area advertisements are assembled during this time, predetermined advertisements are compiled and used.

After the advertising administration agency server 7 performs the operation of joining as a member a lodging business, a specialty product store, restaurant, etc. of a corresponding area, advertisement messages, advertisement data, purchase data, etc. to be transmitted is received and stored. At this time, as described above, the advertising sponsors may receive and store information of time periods during which time advertising is desired.

If an originator makes a call, the advertising administration agency server 7 determines the location of the originator and transmits an advertisement message of an area advertising sponsor corresponding to this location to the originator terminal 1. Further, it is also possible transmit to the originator terminal 1 advertising messages of an area advertising sponsor and of a corresponding time period. The subsequent processes are identical to those described above and so a detailed description thereof will not be provided.

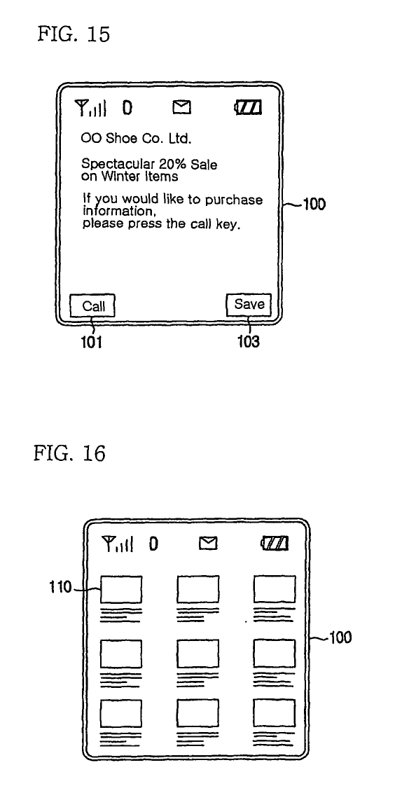

FIG. 15 is a drawing showing an advertisement character message displayed on the screen 100 of the originator terminal 1 following call completion. As described above, in addition to the characters, there may also be display in varying combinations of drawings, pictures, moving pictures, and files. With reference to FIG. 15, if, following completion of a call between an originator and a recipient, the advertising administration agency server 7 transmits to the originator terminal 1 an advertisement message related to advertising received by the originator prior to call connection, a character message such as that shown in FIG. 15 is displayed on the originator terminal 1. If the originator desires to obtain purchase information of the products being advertised after he or she views the character message, the call key 101 or another such designated key on the screen 100 is selected such that purchase information is received from the advertising administration agency server 7 or the advertising sponsor server 9.

It is to be noted that the present invention is not limited to this operation and it is possible to be directly connected to the advertising administration agency server 7 or the advertising sponsor server 9 after the call key 101 is pressed. If the originator does not desire purchase information but would like to save the advertising information, he or she may selected the save key 103 or another such designated key on the screen 100 such that the character message is stored in the originator terminal 1. It is also possible for the messages to be automatically saved in an advertisement reception folder without the originator having to press the save 103 key.

FIG. 16 is a drawing showing transmitted purchase information displayed on the screen 100 of the originator terminal 1 in the case where the originator makes a purchase information request. If the originator presses the call key 101 of FIG. 15, the screen 100 displays information as shown FIG. 16. With reference to FIG. 16, a list of advertised products is displayed on the screen 100. If the originator desires to purchase a product, he or she selects a desired product item 110 from the list of items. If such action is taken, purchase request data are transmitted to the advertising administration agency server 7, after which the advertising administration agency server 7 processes the purchase order of the selected item.

Although a list of products is displayed in FIG. 16, it is also possible to perform display in other formats such as displaying a catalog or a written estimate, etc. A variety of different user interfaces may be provided in addition to these examples.

Further, although these embodiments were described with respect to a ring back tone service using product advertisements, the present invention is not limited to this arrangement and it is possible to provide various different types of information (e.g., information of performances and of cultural events) with the ring back tone service.

In the embodiments of the present invention, character messages are sent after call completion and following the transmission of advertisements. However, the present invention is not limited in this respect and it is possible to simultaneously transmit, when the advertising messages are being sent, drawings, pictures, moving pictures, and file character messages.

In the present invention, an advertisement service using a ring back tone is provided by a common carrier or an advertising administration agency. However, the service of the present invention may be provided by other sources. For example, and in line with future plans to liberalize the wireless Internet network market, a company that leases a network or gateway from a mobile common carrier to perform business operations may provide the service of the present invention, or a company that leases a network or gateway to perform business operations and contracts with an advertising administration agency may provide the service of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The present invention provides a system and method for providing an advertisement service using a ring back tone in which following completion of a call, character, picture, drawing, moving picture, and file messages, or a combination of these messages corresponding to a transmitted advertisement message are transmitted and stored in a communications terminal for viewing at a later time. As a result, the originator is able to better appreciate the contents of an advertising message and remember the same for a longer period of time. Further, the present invention provides a system and method for providing an advertisement service using a ring back tone that transmits purchasing information to the originator when a purchase information request is made by the originator such that the originator is able to view purchase information through his or her communications terminal.

In addition, the present invention provides a system and method for providing an advertisement service using a ring back tone that processes a purchase order when the originator makes a purchase request to thereby allow the purchasing of products through an originator's communications terminal. Also, the present invention provides a system and method for providing an advertisement service using a ring back tone that allows for the selection of a call-connect signal advertising sponsor or an advertising agency according to time period such that a variety of advertisements may be offered. The present invention also provides a system and method for providing an advertisement service using a ring back tone in which the ring back tone advertising sponsor or advertising agency may be selected through both fixed price sales and through auction such that a greater advertising fee may be received from the sponsors at times when there are many calls.

In addition, the present invention provides a system and method for providing an advertisement service using a ring back tone in which a terminal user may individually designate advertising of desired advertising sponsors using the terminal or through the website of a common carrier or advertising administration agency such that only the designated advertising is received, and in which mileage points or another such benefit is received from the selected advertising sponsor to thereby maximize advertising results and provide greater benefit to users. Finally, the present invention provides a system and method for providing an advertisement service using a ring back tone in which after a terminal user becomes a member, the terminal user may at any time individually designate advertising of desired advertising sponsors using his or her terminal or through the website of a common carrier or an advertising administration agency, and in which mileage points or another such benefit is received from the selected advertising sponsor.

1. A method for providing an advertisement service using a ring back tone in a server of a common carrier, the method comprising:
receiving a call request signal from an originator terminal;
extracting an advertisement message from an advertisement database;
transmitting the advertisement message to the originator terminal;
interrupting transmission of the advertisement message when a call connection is made between the originator terminal and a recipient terminal;
extracting advertisement data corresponding to the advertisement message when a call is ended between the originator terminal and the recipient terminal; and
transmitting the extracted advertisement data to the originator terminal.

2. A method for providing an advertisement service using a ring back tone in an advertising administration agency server, comprising:
receiving a call request signal of an originator terminal from a common carrier;
extracting an advertisement message from an advertisement database;
transmitting the advertisement message to the common carrier, the advertisement message being transmitted to the originator terminal through the common carrier;
interrupting transmission of the advertisement message when a call connection signal is received from the common carrier;
extracting advertisement data corresponding to the advertisement message when a call completion signal is received from the common carrier; and
transmitting the extracted advertisement data to the common carrier, the advertisement data being transmitted to the originator terminal through the common carrier.

3. The method of claim 1, wherein the advertising data are at least one of character messages, drawing messages, picture messages, moving pictures, and files.

4. The method of claim 3, wherein the step of transmitting the extracted advertisement data further comprises the step of transmitting, together with the advertisement data, connection information to connect the originator terminal with the advertising administration agency server or an advertising sponsor server.

5. The method of claim 1, wherein the step of extracting advertisement data further comprises the steps of:
extracting originator and recipient information from the call request signal; and
determining if the originator or the recipient is a member using the originator and recipient information.

6. The method of claim 1, further comprising the step of registering an advertising sponsor prior to the receiving a call request signal.

7. The method of claim 6, wherein the step of registering an advertising sponsor further comprises steps of:
receiving a member admission request signal from an advertising sponsor server;
transmitting a member admission approval signal to the advertising sponsor server; and
receiving and storing advertisement messages and advertisement data from the advertising sponsor server.

8. The method of claim 7, wherein the step of receiving and storing advertisement messages and advertisement data further comprises the step of receiving and storing information of advertisement message transmission time periods from the advertising sponsor server.

9. The method of claim 8, wherein the step of receiving and storing information of advertisement message time periods further comprises the steps of:
receiving a bidding price from the advertising sponsor server;
classifying and storing advertising sponsor information and transmission time period information according to time period;
selecting an advertising sponsor with the highest bidding price as a successful bidder for each transmission time period; and
transmitting successful bid information to the servers of the selected advertising sponsors.

10. The method of claim 1, further comprising registering a subscriber terminal as a member when a member admission request signal is received from the subscriber terminal.

11. The method of claim 10, further comprising receiving the input of desired advertisement type from the subscriber terminal, and storing the selected advertisement type.

12. The method of claim 11, wherein a subscriber that joins as a member may individually and at any time apply for and revise advertising of a desired advertising sponsor using his or her terminal or through a website of a common carrier or an advertising administration agency.

13. The method of claim 11, wherein the extracting an advertisement message comprises extracting advertisement type information corresponding to the subscriber terminal.

14. The method of claim 10, wherein the step of registering a member further comprises the steps of:
receiving a transmitting advertisement member request signal that allows a subscriber to receive advertisement messages when the subscriber will be transmitting from the subscriber terminal; and
storing subscriber terminal information in a transmitting advertisement member database.

15. The method of claim 10, wherein the step of registering a member further comprises the steps of:
receiving a receiving advertisement member request signal that allows an originator to receive advertisement messages when the originator will be transmitting to the subscriber terminal; and
storing subscriber terminal information in a receiving advertisement member database.

16. The method of claim 10, wherein the step of registering a member further comprises the steps of:
receiving a transmitting/receiving advertisement member request signal that allows a subscriber and an originator to receive advertisement messages, the subscriber receiving advertisement messages in the case where the subscriber transmits from the subscriber terminal and the originator receiving advertisement message in the case where the originator will be transmitting to the subscriber terminal; and
storing subscriber terminal information in a transmitting/receiving advertisement member database.

17. The method of claim 1, wherein the step of extracting an advertisement message from an advertisement database further comprises the steps of:
extracting a present position of the originator terminal;
extracting an area advertising sponsor corresponding to the present position; and
extracting advertisement messages corresponding to the area advertising sponsor.

18. The method as in claim 1, further comprising the steps of: receiving a purchase information request signal from an originator terminal;
extracting purchase information corresponding to the advertisement data; and
transmitting the purchase information to the originator terminal.

19. The method of claim 18, wherein the purchase information includes at least one of estimate information, drawings, pictures, moving pictures, files, and catalog information.

20. The method of claim 18, wherein in the case where the advertisement message is music, the purchase information is CD information that includes music.

21. The method of claim 18, further comprising the steps of:
receiving a purchase request signal that includes information of a purchase product from the originator terminal; and
processing a purchase order of the purchase product based on the purchase request signal.

22. The method of claim 21, further comprising the steps of:
renewing and storing the accumulated points of the originator; and
transmitting renewed accumulated point information to the originator terminal.

23. The method of claim 1, further comprising the steps of:
receiving a purchase request signal that includes information of a purchase product from the originator terminal; and
processing a purchase order of the purchase product based on the purchase request signal.

24. (canceled)

25. A system for providing an advertisement service using a ring back tone, comprising:
a receiver receiving from a common carrier a call connection request signal of an originator terminal;
a member management unit extracting information of an originator and a recipient from the call connection request signal to determine if the originator or the recipient is a member, and managing member information;
an advertisement message extracting unit extracting advertisement messages to be transmitted from an advertisement message database; an advertisement data extracting unit extracting advertisement data from the advertisement database; and
a transmitter transmitting an advertisement message extracted in the advertisement message extracting unit to the originator terminal through the common carrier after a member authorization signal is received from the member management unit, and transmitting advertisement data when a call between the originator and the recipient is ended.

26. The system of claim 25, further comprising:
a purchase information extracting unit extracting purchase information from a purchase information database; and
a purchase processor performing purchase processing of a purchase product in the case where a purchase request signal that includes purchase product information is received from the originator terminal, the purchase processor performing this task based on the product information.

27. The system of claim 25, wherein the advertisement information includes at least one of character messages, moving pictures, and files.

28. The method of claim 2, wherein the advertising data are at least one of character messages, drawing messages, picture messages, moving pictures, and files.

29. The method of claim 2, wherein the step of extracting advertisement data further comprises the steps of:
extracting originator and recipient information from the call request signal; and
determining if the originator or the recipient is a member using the originator and recipient information.

30. The method of claim 2, further comprising the step of registering an advertising sponsor prior to the receiving a call request signal.

31. The method of claim 2, further comprising registering a subscriber terminal as a member when a member admission request signal is received from the subscriber terminal.

32. The method of claim 2, wherein the step of extracting an advertisement message from an advertisement database further comprises the steps of:
extracting a present position of the originator terminal;
extracting an area advertising sponsor corresponding to the present position; and
extracting advertisement messages corresponding to the area advertising sponsor.

33. The method as in claim 2, further comprising the steps of: receiving a purchase information request signal from an originator terminal;
extracting purchase information corresponding to the advertisement data; and
transmitting the purchase information to the originator terminal.

34. The method of claim 2, further comprising the steps of:
receiving a purchase request signal that includes information of a purchase product from the originator terminal; and
processing a purchase order of the purchase product based on the purchase request signal.
